(19) United States
(12) Patent Application Publication
(10) Pub. No.: US 2026/0051567 A1
(43) Pub. Date: Feb. 19, 2026

(54) SEALING FOR IMMERSION COOLED BATTERY PACK

(71) Applicant: FCA US LLC, Auburn Hills, MI (US)

(72) Inventors: Tae Hyun Kim, Auburn Hills, MI (US); Daniel E Hornback, Auburn Hills, MI (US)

(21) Appl. No.: 18/808,613

(22) Filed: Aug. 19, 2024

(51) Int. Cl. H01M 10/6567; H01M 10/613; H01M 10/625; H01M 50/233; H01M 50/249; H01M 50/262

(52) U.S. Cl. CPC H01M 10/6567; H01M 10/613; H01M 10/625; H01M 50/233; H01M 50/249; H01M 50/262

(57) ABSTRACT

A battery pack assembly for an electrified vehicle includes a main body assembly having a lower battery housing, an upper battery housing, at least one battery cell, fluid and tape. The upper and lower battery housings are coupled together at a mechanical joint. The battery cell is disposed within the main body assembly. The fluid is housed within the main body assembly. The tape is coupled between the upper and lower battery housings. The tape provides a barrier between the upper and lower battery housing and inhibits the fluid from leaking from the main body assembly in the event of a failure of the mechanical joint.

### FIELD

The present application generally relates to electrified vehicles and, more particularly, to a seal arrangement for an immersion cooled battery pack.

### BACKGROUND

An electrified vehicle (hybrid electric, plug-in hybrid electric, range-extended electric, battery electric, etc.) includes at least one battery system and at least one electric motor. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor.

The high voltage battery system generally includes a battery pack assembly or module that includes a housing that houses one or more battery packs. Some battery packs are immersion cooled where dielectric fluid flows internally to cool the battery cells. Any leakage of the dielectric fluid from the pack or module enclosure from poor sealing or from an impact can cause detrimental loss of cooling capability and lead to thermal propagation of cells. Accordingly, while such conventional battery pack assemblies do work well for their intended purpose, there exists an opportunity for improvement in the relevant art.

### SUMMARY

According to one example aspect of the invention, a battery pack assembly for an electrified vehicle includes a main body assembly having a lower battery housing, an upper battery housing, at least one battery cell, fluid and tape. The upper and lower battery housings are coupled together at a mechanical joint. The battery cell is disposed within the main body assembly. The fluid is housed within the main body assembly. The tape is coupled between the upper and lower battery housings. The tape provides a barrier between the upper and lower battery housing and inhibits the fluid from leaking from the main body assembly in the event of a failure of the mechanical joint.

In some implementations, the tape is a stretchy tear resistant tape.

According to another example aspect of the invention, the tape is dielectric bonding tape.

In some implementations, the main body assembly further comprises an upper bond surface disposed on the upper battery housing and a lower bond surface disposed on the lower battery housing.

In other examples, the upper bond surface and the lower bond surface comprises adhesive.

In additional implementations, the tape is coupled to the upper and lower bond surfaces.

In additional arrangements, the upper battery housing defines an upper groove and the lower battery housing defines a lower groove. The upper and lower grooves collectively define a groove. The tape is received within the groove.

According to another example aspect of the invention, the tape is accordion folded into the groove.

In some implementations, the mechanical joint comprises at least one of a welding, crimping, and mechanical fastening.

In additional examples, the fluid comprises dielectric fluid.

In other arrangements, the battery pack is immersion cooled.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having a battery system including a battery pack assembly according to the principles of the present application;

FIG. 2 is front perspective view of a main body assembly of the battery pack assembly of the battery system of FIG. 1 according to the principles of the present application;

FIG. 3A is a sectional side view of upper and lower battery housings of the main body assembly of FIG. 2 showing dielectric tape attached to a lower bond surface of the lower battery housing prior to assembly to the upper battery housing according to a first embodiment of the principles of the present application;

FIG. 3B is a sectional view of the upper and lower battery housings of the main body assembly of FIG. 3A showing the dielectric tape attached to an upper bond surface of the upper battery housing subsequent to assembly of the upper battery housing to the lower battery housing according to principles of the present application;

FIG. 3C is a sectional view of the upper and lower battery housings of the main body assembly of FIG. 3B shown after mechanical joint failure between the upper and lower battery housings, the dielectric tape shown spanning the ruptured joint and inhibiting, preventing or delaying dielectric fluid inside the main body assembly from leaking out, and with the upper and lower battery housing in a first relative position;

FIG. 3D is a sectional view of the upper and lower battery housings of the main body assembly of FIG. 3C shown after mechanical joint failure between the upper and lower battery housings, the dielectric tape shown spanning the ruptured joint and inhibiting, preventing or delaying dielectric fluid inside the main body assembly from leaking out, and with the upper and lower battery housings in a second relative position;

FIG. 4A is a sectional side view of upper and lower battery housings of the main body assembly of FIG. 2 that incorporates a groove therein and showing dielectric tape attached to a lower bond surface of the lower battery housing prior to assembly to the upper battery housing according to a second embodiment of the principles of the present application;

FIG. 4B is a sectional view of the top and bottom cover of the main body assembly of FIG. 4A showing the dielectric tape attached to an upper bond surface of the upper battery housing subsequent to assembly of the upper battery housing to the lower battery housing according to principles of the present application;

FIG. 4C is a sectional view of the upper and lower battery housings of the main body assembly of FIG. 4B shown after mechanical joint failure between the upper and lower battery housings, the dielectric tape shown spanning the ruptured joint and inhibiting, preventing or delaying dielectric fluid inside the main body assembly from leaking out, and with the upper and lower battery housing in a first relative position; and

FIG. 4D is a sectional view of the upper and lower battery housings of the main body assembly of FIG. 4C shown after mechanical joint failure between the upper and lower battery housings, the dielectric tape shown spanning the ruptured joint and inhibiting, preventing or delaying dielectric fluid inside the main body assembly from leaking out, and with the upper and lower battery housings in a second relative position.

### DESCRIPTION

As discussed above, a high voltage battery system generally includes a battery pack assembly that includes a housing that houses one or more battery packs. Some battery packs are immersion cooled where dielectric fluid flows internally to cool the battery cells. Any leakage of the dielectric fluid from the pack or module enclosure from poor sealing or from an impact can cause detrimental loss of cooling capability and lead to thermal propagation of cells.

Accordingly, the present disclosure provides a sealing configuration for an immersion cooled battery pack. The sealing configuration incorporates stretch tear resistant tape such as dielectric tape between the upper and lower battery housing of the main body assembly. The dielectric tape provides a robust stretchy seal function between the upper and lower battery housing of the main body assembly in the event of an impact that may cause mechanical failure at the joint the secures the upper and lower battery housing. The dielectric tape spans the ruptured joint and prevents or delays dielectric fluid inside the main body assembly from leaking out.

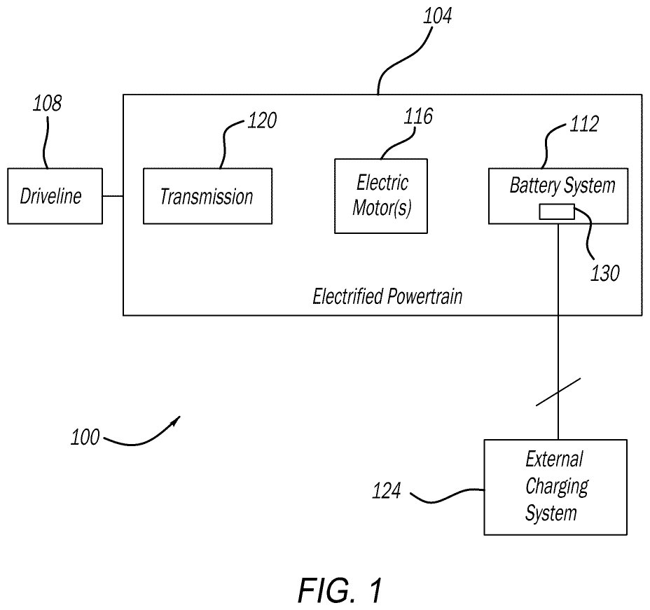

Referring now to FIG. 1, a functional block diagram of an example electrified vehicle 100 (also referred to herein as “vehicle 100”) according to the principles of the present application is illustrated. The vehicle 100 includes an electrified powertrain 104 configured to generate and transfer drive torque to a driveline 108 of the vehicle 100 for propulsion. The electrified powertrain 104 generally comprises a high voltage battery system 112 (also referred to herein as “battery system 112”), one or more electric motors 116, and a transmission 120. The battery system 112 is selectively connectable (e.g., by the driver) to an external charging system 124 (also referred to herein as “charger 124”) for charging of the battery system 112. The battery system 112 includes at least one battery pack assembly 130.

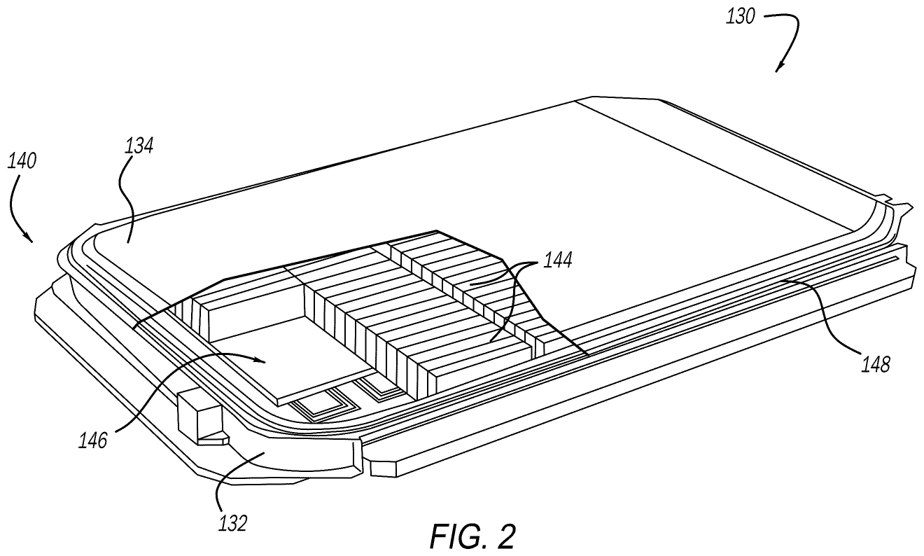

Referring now to FIG. 2, an exemplary battery pack assembly 130 will be described. In examples, the battery pack assembly 130 can generally include a lower battery housing 132 and an upper battery housing 134. The battery pack assembly 130 according to one example of the present disclosure includes a main body assembly 140. The main body assembly 140 generally represents the battery pack assembly 130 with battery cells 144 being assembled therein for illustration purposes. In general, however, the battery pack assembly 130 can include the battery cells 144 housed in dielectric fluid 146 between the lower battery housing 132 and the upper battery housing 134.

The lower battery housing 132 and the upper battery housing 134 can be mechanically assembled and coupled together by a joint 148. The joint 148 can include any one or combinations of welding, crimping, mechanical fastening or other joining techniques that couple the lower battery housing 132 and the upper battery housing 134. While the exemplary battery pack assembly 130 is shown having no modules, the sealing techniques described herein can be applied to any battery pack assembly 130 to sealingly secure the lower battery housing 132 and the upper battery housing 134.

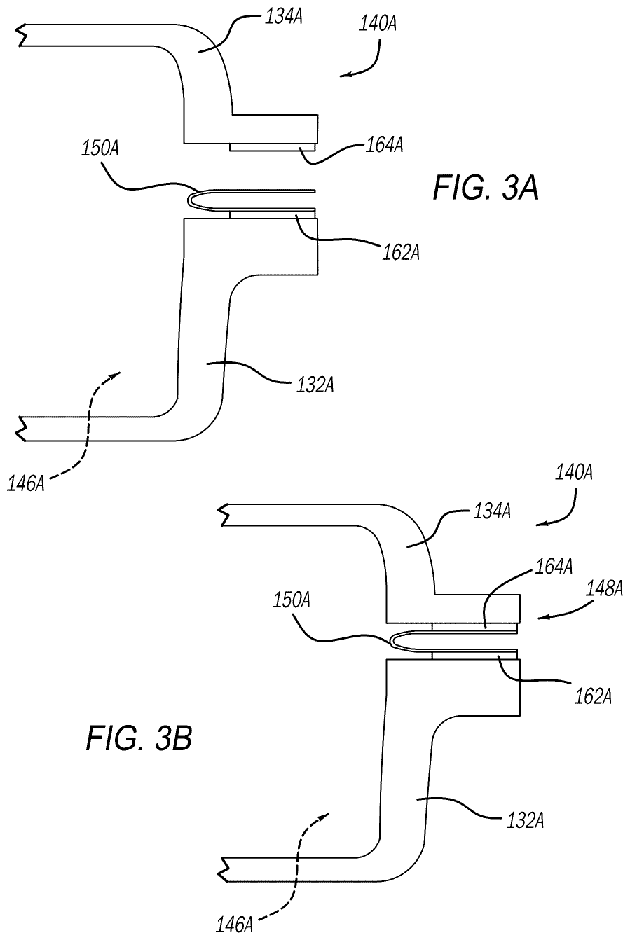

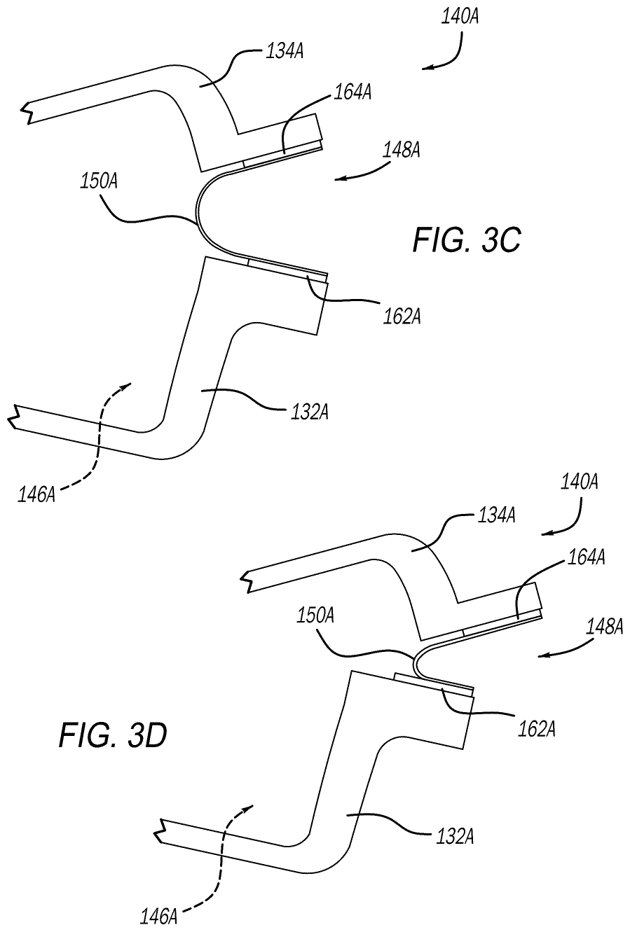

Turning now to FIGS. 3A-3D, a sealing configuration according to a first embodiment of the present disclosure will be described. FIG. 3A is a sectional side view of upper and lower battery housings 134A, 132A of the main body assembly 140A showing dielectric tape 150A attached to a lower bond surface 162A of the lower battery housing 132A prior to assembly to the upper battery housing 134A according to a first embodiment of the principles of the present application.

FIG. 3B is a sectional view of the upper and lower battery housings 134A, 132A of the main body assembly 140A of FIG. 3A showing the dielectric tape 150A attached to an upper bond surface 164A of the upper battery housing 134A subsequent to assembly of the upper battery housing 134A to the lower battery housing 132A according to principles of the present application. The lower bond surface 162A and upper bond surface 164A can include any adhesive material that adheres to the upper and lower housings 132A, 134A and the dielectric tape 150A.

With reference to FIG. 3C, a sectional view of the upper and lower battery housings 134A, 132A of the main body assembly 140A of FIG. 3B is shown after mechanical joint failure between the upper and lower battery housings 134A, 132A, the dielectric tape 150A shown spanning the ruptured joint and inhibiting, preventing or delaying dielectric fluid 146 inside the main body assembly 140A from leaking out, and with the upper and lower battery housing 134A, 132A in a first relative position.

FIG. 3D is a sectional view of the upper and lower battery housings 134A, 132A of the main body assembly 140A of FIG. 3C shown after failure of the mechanical joint 148A between the upper and lower battery housings 134A, 132A, the dielectric tape 150A shown spanning the ruptured joint and providing a barrier between the upper and lower battery housing 134A, 132A. The dielectric tape 150A inhibits, prevents or delays dielectric fluid 146A inside the main body assembly 140A from leaking out of the main body assembly 140A. The upper and lower battery housings 134A, 132A are shown in a second relative position in FIG. 3D.

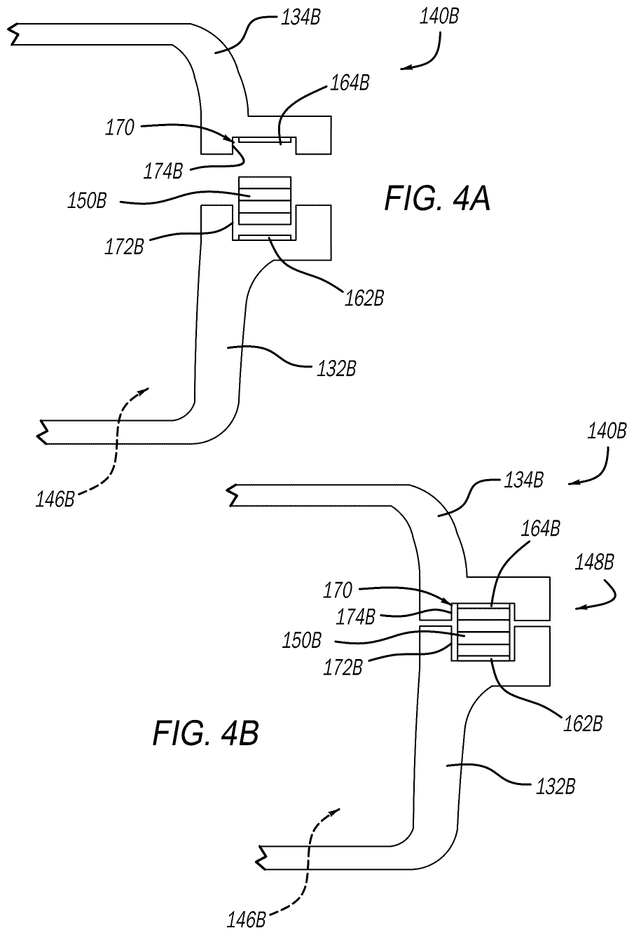

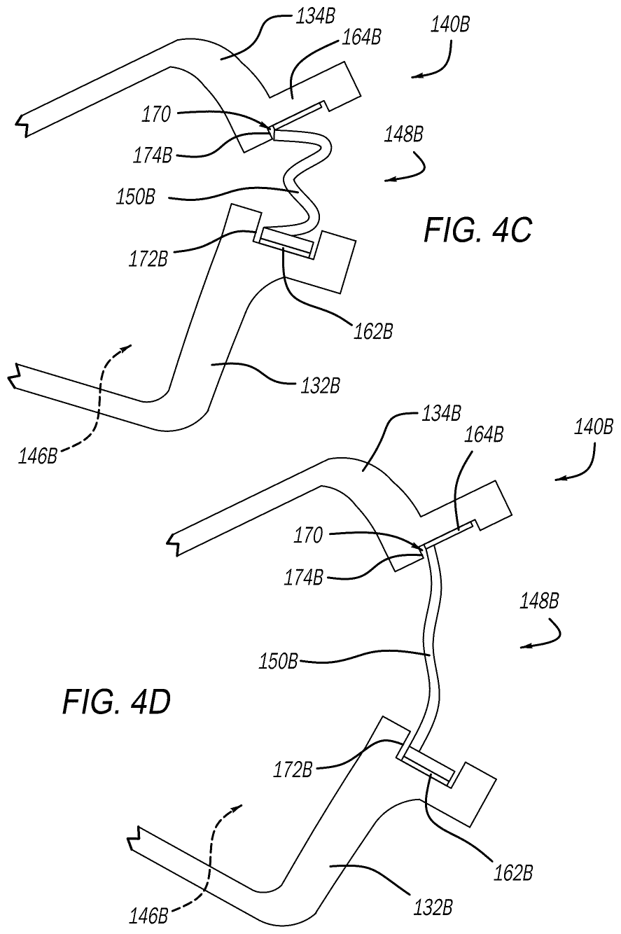

Turning now to FIGS. 4A-4D, a sealing configuration according to a first embodiment of the present disclosure will be described. FIG. 4A is a sectional side view of upper and lower battery housings 134B, 132B of the main body assembly 140B of FIG. 2 that incorporates a groove 170 therein and showing dielectric tape 150B attached to a lower bond surface 162B of the lower battery housing 132B prior to assembly to the upper battery housing 134B according to a second embodiment of the principles of the present application. The groove 170 is collectively defined by a lower groove 172 defined on the lower battery housing 132B and an upper groove 174 defined on the upper battery housing 134B.

FIG. 4B is a sectional view of the upper and lower battery housings 134B, 132B of the main body assembly 140B of FIG. 4A showing the dielectric tape 150B attached to an upper bond surface 164B of the upper battery housing 134B subsequent to assembly of the upper battery housing 134B to the lower battery housing 132B according to principles of the present application. The dielectric tape 150B can be accordion folded into the groove 170. The dielectric tape 150B can provide additional coverage (e.g., length and/or width) that spans a greater distance between the upper and lower battery housings 134B, 132B.

FIG. 4C is a sectional view of the upper and lower battery housings 134B, 132B of the main body assembly 140B of FIG. 4B shown after the mechanical joint 148B has failed between the upper and lower battery housings 134B, 132B, the dielectric tape 150B shown spanning the ruptured joint and inhibiting, preventing or delaying dielectric fluid 146B inside the main body assembly 140B from leaking out, and with the upper and lower battery housing 134B, 132B in a first relative position.

FIG. 4D is a sectional view of the upper and lower battery housings 134B, 132B of the main body assembly 140B of FIG. 4C shown after the mechanical joint 148B has failed between the upper and lower battery housings 134B, 132B, the dielectric tape 150B shown spanning the ruptured joint and providing a barrier between the upper and lower battery housing 134B, 132B. The dielectric tape 150B inhibits, prevents or delays dielectric fluid 146B inside the main body assembly 140B from leaking out of the main body assembly 140B. The upper and lower battery housings 134B, 132B are shown in a second relative position in FIG. 4D.

The sealing arrangement disclosed herein that incorporates the dielectric tape 150A, 150B in an immersion cooled battery pack or battery module seal face provides extra safety measures in inhibiting or preventing dielectric fluid leakage such as during an impact event that could cause the mechanical joint 148 to fail and allow the upper and lower battery housings 134, 132 to move relative to each other. This is important as any potential leakage, especially a sudden loss of dielectric fluid in immersion cooled environments can be detrimental in reducing the effectiveness of the cooling system. The sealing techniques disclosed herein are further cost effective and simple to implement.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A battery pack assembly for an electrified vehicle, the battery pack assembly comprising:
a main body assembly comprising:
a lower battery housing;
an upper battery housing, the upper and lower battery housings coupled together at a mechanical joint;
at least one battery cell disposed within the main body assembly;
fluid housed within the main body assembly; and
tape coupled between the upper and lower battery housings, the tape providing a barrier between the upper and lower battery housing and inhibiting the fluid from leaking from the main body assembly in the event of a failure of the mechanical joint.

2. The battery pack assembly of claim 1, wherein the tape is a stretchy tear resistant tape.

3. The battery pack assembly of claim 1, wherein the tape is dielectric bonding tape.

4. The battery pack assembly of claim 1, wherein the main body assembly further comprises:
an upper bond surface disposed on the upper battery housing; and
a lower bond surface disposed on the lower battery housing.

5. The battery pack assembly of claim 4, wherein the upper bond surface and the lower bond surface comprises adhesive.

6. The battery pack assembly of claim 4, wherein the tape is coupled to the upper and lower bond surfaces.

7. The battery pack assembly of claim 1, wherein the upper battery housing defines an upper groove and the lower battery housing defines a lower groove, the upper and lower grooves collectively defining a groove, the tape being received at the groove.

8. The battery pack assembly of claim 7, wherein the tape is accordion folded into the groove.

9. The battery pack assembly of claim 1, wherein the mechanical joint comprises at least one of a welding, crimping, and mechanical fastening.

10. The battery pack assembly of claim 1, wherein the fluid comprises dielectric fluid.

11. The battery pack assembly of claim 1, wherein the main body assembly is immersion cooled.
